(19) United States
(12) Patent Application Publication
(10) Pub. No.: US 2005/0043985 A1
(43) Pub. Date: Feb. 24, 2005

(54) System and methods for evaluating opportunities

(76) Inventor: Scott R. Gillespie, Solon, OH (US)

Correspondence Address: HAHN LOESER & PARKS, LLP, One GOJO Plaza, Suite 300, AKRON, OH, 44311-1076, US

(21) Appl. No.: 10/499,421

(22) PCT Filed: Dec. 20, 2002
(86) PCT No.: PCT/US02/41321

Related U.S. Application Data
(60) Provisional application No. 60/344,906, filed on Dec. 21, 2001.

(51) Int. Cl. G06F 17/60

(52) U.S. Cl. 705/10

(57) ABSTRACT

The invention is directed to systems and methods for evaluating the merits of an opportunity. A survey system having a plurality of survey questions or statements relating to the opportunity is provided to a user. The survey is responded to by a user, and information relating to the survey questions or statements, evaluation parameters relating to the questions or statements, potential responses, evaluations parameters relating to responses, and information relating to actual responses is stored (10). The actual responses are evaluated against pre-defined criteria and generating an evaluation record (12). At least one user is provided with information regarding the evaluation of the opportunity along with a recommendation relating to the opportunity (14).

### TECHNICAL FIELD

This invention relates to systems and methods for evaluating opportunities, such as travel opportunities, and the associated benefits and costs of such opportunities. Particularly in a business setting, the invention enables better management of the costs and benefits of opportunities. More particularly, the invention relates to systems and methods for analyzing opportunities using a set of predefined characteristics or criteria, weights and scores or other information to evaluate the benefit of an opportunity. The invention is also directed to analyzing and evaluating characteristics of opportunities within an organization or relative to those of other organizations, as related to aggregated information relating to such opportunities.

### BACKGROUND OF THE INVENTION

Businesses and corporations spend a great deal of their resources each year on business-related travel. For example, travel is one of the largest non-production cost categories for many businesses. For example, in the United States, corporations may spend as much as one hundred billion dollars each year on business-related travel. As the amount of resources being expended on business travel is significant, businesses faces several problems trying to control this expense and maximize its benefit.

As an example, in many businesses, travel is purchased directly by the traveler with little or no pre-approval from a supervisor or other management personnel. When businesses management does not have a method in place for authorizing a prospective trip, the authorization process is often seen as time consuming and of little value given the subjective nature of attempting to evaluate the merits of a prospective business trip. Current pre-trip authorization processes typically require a person authorized by the organization to approve or reject a proposed trip. Thus, it is common in such cases, that management or supervisors rubber-stamp the pre-trip authorization request, without significant, consistent or objective evaluation of the merits of the travel relative to the cost. A need still exists for systems and methods to reduce costs associated with travel by more objectively and consistently evaluating the trip's potential merit, so that trips having insufficient expected value are not taken, and travel costs are avoided.

Additionally, organizations generally have no practical way of forecasting their near-term travel requirements, other than monitoring trip reservations, which have already been booked by travelers via their corporate travel agencies or self-booking tools. Although systems as mentioned above may allow cost associated with such travel bookings to be monitored, the value of the trip relative to using non-travel alternatives is generally not considered. Further, a business cannot easily monitor prospective trips being contemplated by the organization's travelers, as such prospective trips have often not yet been booked, and would not be included in the pre-trip reservation data.

At the same time that the difficulties with monitoring and controlling travel expenses are increasing, the potential alternatives for travel continue to grow, such as usage of the telephone, video conferencing capabilities or the Internet. These prospective alternatives to any given prospective business trip may not be sufficiently taken into consideration. As such technologies continue to provide viable alternatives, there is a significant opportunity to reduce travel costs without adverse consequences to the organization. To reduce costs associated with travel, organizations presently have no consistent and more objective way of helping or assisting travelers to decide if a business trip is worth taking or not. Typically in organizations, if travel expenses must be reduced due to economic circumstances or the like, a management decision is made to “eliminate all non-critical travel for a period of time” or some other drastic measure. Thereafter, if economic conditions improve or the like, such organizations have no practical, objective and consistent way of controlling the subsequent increase in travel which may be expected, as each traveler is guided largely by their own perceptions of what constitutes a worthwhile prospective trip.

In that the merits of traveling to conduct business are rarely or poorly assessed, an organization's management simply has not had good tools available to evaluate the benefits obtained by employees having traveled to conduct their business. It would therefore be of significant value to provide an efficient process and system that would allow business or individuals to evaluate prospective or consummated travel opportunities. In the example of a travel opportunity, it would be advantageous to provide the ability to evaluate the travel opportunity against predefined criteria or factors to receive an indication of the benefits of traveling, such as relative to the cost and/or using non-travel alternatives. It would be of significant benefit to provide a system and method for allowing travelers to quickly, easily and more objectively evaluate the merits of a prospective trip in keeping with the views of an organization's management. It would further provide benefit to allow management to monitor prospective travel plans, including trips that have not yet been booked. There is a need to provide systems and methods to assist companies with eliminating future travel, which is likely to be of little or nil value, and to help organizations assess the reasons for and the value of travel within their organization. Additionally, it may be valuable for an organization or entity to monitor the characteristics of prospective or consummated trips in light of the organization's historical data and/or relative to other organization's travel data.

Similar to travel related opportunities, businesses and organizations, as well as individuals, make decisions relating to opportunities, which they are not able to evaluate with respect to objective criteria or rules/recommendations relating to such opportunities.

### SUMMARY OF THE INVENTION

Based upon the foregoing, the present invention provides systems and methods for providing the desired advantages and benefits as mentioned above. The invention provides a system and method for evaluating the merits of an opportunity, which provides a survey system having a plurality of survey questions or statements relating to the opportunity. The survey is responded to by a user, and information relating to the survey questions or statements, evaluation parameters relating to the questions or statements, potential responses, evaluation parameters relating to responses, and information relating to actual responses. The actual responses are evaluated against pre-defined criteria and generate an evaluation record. At least one user is provided with information regarding the evaluation of said opportunity along with a recommendation relating to the opportunity. The systems and methods are designed to allow users to accomplish a variety of tasks relative to an opportunity, such as a prospective travel opportunity, including evaluating the prospective opportunity against a set of pre-defined criteria, with the particular criteria designed by the user, the system's administrator, the management of an organization or other entity. The invention may further allow the user to receive an indication of the merits of the prospective opportunity if desired. The user, the system's administrator, an organization's management or other entity can establish rules and/or recommendations based upon the prospective opportunity's scoring, rating or valuation as provided by the invention. The system and methods may also provide information relative to prospective opportunities, which can be recorded, and/or communicated to an organization's management for monitoring opportunities, such as travel opportunities and travel requirements of a user or organization. The invention may provide a system-defined recommendation, which is recorded and communicated along with the traveler's intention regarding a prospective trip. The system and methods can monitor and report the status, evaluation and expected cost of the prospective opportunities by users. For example, subsequent to a given trip taken by a traveler, the system and methods according to the invention allow a user to retroactively input information relative to a trip taken and rate or otherwise evaluate the merits of having taken the trip. In this manner, the systems and methods according to the invention can store information relative to particular trips and the trip record's characteristics for later analysis. Such information can be accumulated for a number of organizations to compile travel data; which can then be used by others to compare and evaluate their own travel characteristics.

In another aspect, the present invention provides in a computer system comprising a data input device, a data storage device, a processor and a user interface, a method of evaluating opportunities.

The invention also provides a system for evaluating travel opportunities comprising a computer system for receiving information from a user regarding a travel opportunity.

A program in the computer system presents a plurality of survey questions relating to a prospective travel opportunity to the user, and selective storage of information selected form the group consisting of survey questions, question weights, potential responses, response weights, actual responses or combinations thereof. The program further evaluates actual responses to the plurality of survey questions against pre-defined criteria to provide a score relative to the prospective travel opportunity, and selectively communicates information regarding the merits of the prospective travel opportunity based upon the evaluation against pre-defined criteria.

In addition, the method and system according to the invention can be used to establish travel rules and/or recommendations based upon a prospective travel opportunity rating or score, and can record and communicate the rating or score of a prospective travel opportunity as well as the system-defined recommendation and traveler's intentions about the prospective travel opportunity to a central location for further evaluation. The system and methods according to the invention can be used to monitor and report the status, score and expected cost of prospective travel opportunities, among other characteristics pertaining to the travel opportunity, and can allow the traveler to retroactively rate the merits of having taken a particular trip and to store and evaluate trip records characteristics for evaluation of an organization's travel and travel requirements.

In a further aspect, the invention may provide a system and methods for acquiring information as to a user's travel characteristics and compile such information into travel characteristic information to be accessed and used by an organization or other user to evaluate the travel characteristics within an organization or relative to other organizations or users. In such system and methods, the information may be anonymized to protect particular information of a user, while making the information available for other users.

### BRIEF DESCRIPTION OF THE DRAWINGS

The invention will become more clearly understood from the following description of embodiments thereof, in connection with the accompanying drawings, wherein:

FIG. 1 is a flow diagram of an embodiment of the method according to the invention.

FIG. 2 is a flow chart showing further aspect of the system and method according to the invention.

FIGS. 3A and 3B are sample travel management reports and summaries according to the invention.

FIG. 4 is a sample of trip records related to another organization, which have been aggregated and/or made anonymous.

FIG. 5 is a flow diagram of an embodiment of the method according to the invention.

FIG. 6 is a flow diagram of an embodiment of a system configuration step according to the present invention.

FIG. 7 is a sample question or answer editor function according to the present invention.

FIG. 8 is a sample survey editor function according to the present invention.

FIG. 9 is a sample response weight editor function according to the present invention.

FIG. 10 is a flow diagram of an embodiment of a pre-trip survey step according to the present invention.

FIG. 11 is a sample pre-trip initiation function according to the present invention.

FIG. 12 is a sample pre-trip survey question according to the present invention.

FIG. 13 is a sample completed survey summary according to the present invention.

FIG. 14 is a sample survey result according to the present invention.

FIG. 15 is a sample notification editor according to the present invention.

FIG. 16 is a flow diagram of an embodiment of a value rating step according to the present invention.

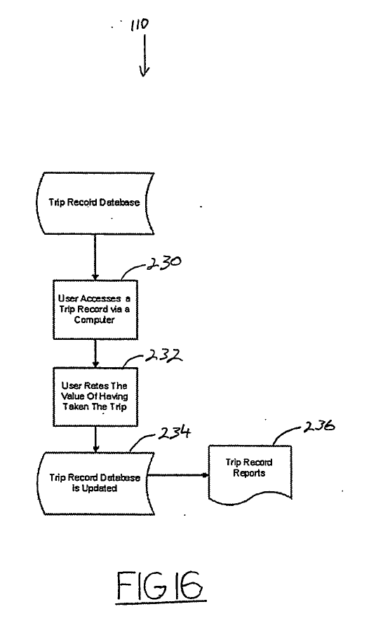

FIG. 17 is a sample trip-record list according to the present invention.

FIG. 18 is a sample internal analysis function according to the present invention.

FIG. 19 is a flow diagram of an embodiment of a benchmarking step according to the present invention.

FIG. 20 is a sample benchmark selection function according to the present invention.

FIG. 21 is a sample benchmark report according to the present invention.

### DETAILED DESCRIPTION OF THE INVENTION

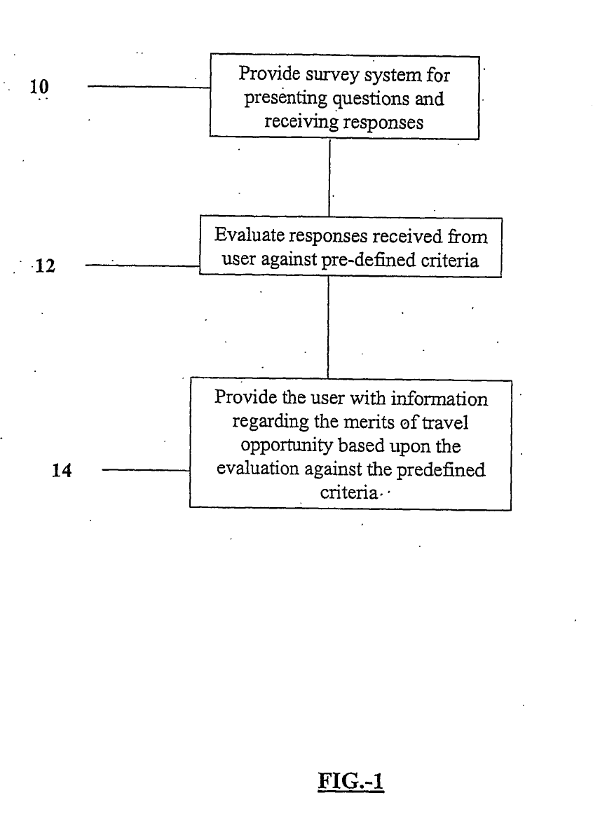

Referring now to FIG. 1, a method according to the invention will be described, which is carried out by a system according to the invention, which may be implemented in a computer system, a global information system or other desired manners. The invention will be described with reference to the evaluation of a travel opportunity, which may be prospective or consummated, for an individual or organization. It should be understood that similar embodiments are contemplated for other opportunities, to allow more objective evaluation thereof. The invention embodies the ability to evaluate prospective and consummated opportunities of an organization and relative to aggregated data related to similar types of opportunities of other organizations. The opportunities may vary, and may be personal or organizational, and are not limited to the embodiments as described herein. For example, other opportunities that it would be beneficial to evaluate according to the invention may include investment decisions, resource allocation, purchasing or other capital expenditures, new client or customer qualification or relationships, etc. As seen in FIG. 1, as a first step, the system and method according to the invention provide a survey system for presenting questions and receiving responses from a user at 10. The system according to the invention is capable of facilitating the creation, editing, storing and associating of survey-style questions or statements (hereinafter questions), question weights or other evaluation parameters that may be given to questions, potential responses relevant to each question, response weights that may be given to responses, and actual responses relative to a prospective opportunity, such as a trip and/or traveler. This survey system may be implemented in writing, but preferably via a user interface in a computer system comprising a data input device, a data storage device, a processor and a user interface. As an example, the methods and system could be implemented via the Internet or other global information system, so as to be accessible to a wide variety of users via a Web page or the like. In such an embodiment, a user could access the system via a user code and password to allow the particular information relating to an organization or other entity to be input and accessed.

In the business setting, the survey system may be configured to provide an administrator with the ability to customize the survey questions, the question weights, the potential responses to each question, a weighting or other evaluation parameter associated with each potential response, or to create and edit other aspects of the survey system or systems used for evaluation, comparison or other analysis of the travel information. Such information may include characteristics about 1) the user, such as job function, travel habits, primary reasons for traveling, types of trips taken, number of trips taken, and the like; or 2) the user's organization, such as the organization's industry, its revenues, number of employees, annual travel expenditures, or the like.

Thereafter, at step 12, the system and method evaluates responses received from a user against pre-defined criteria. In an example, the system may be designed to score a user's answers to a set of questions that have been created by the survey system's administrator, using the questions, the question weights, the user's selected responses, and the response weights or other information, which may collectively be referred to as a “trip record”. Additional information may be included in the trip record, such as that associated with the user's characteristics and/or the organization's characteristics. Thereafter at 14, the system and method may provide the user or others with information regarding the merits of a travel opportunity, such as a score and/or a recommendation or the like, based upon the evaluation performed using the predefined criteria. Other organizations' information may then be aggregated or accumulated and anonymized to allow users to obtain and evaluate travel characteristics of larger related groups or based upon predetermined demographics or the like. The system may be used to store the fields and records relating to the survey questions, question weights, relevant potential responses, response weights, and selected responses for an opportunity. In this embodiment, the user may also or alternatively input travel characteristics for completed travel to facilitate evaluating past trips or other opportunities. The evaluations of prospective travel or past travel may then be communicated to designated users via the Web page and/or via e-mail or other computerized systems to make the survey and results of the surveys available to potential travelers or users, and/or their organization's authorized employees.

In the above described system and method, it should be noted that the system does not require questions or inputs relating to the prospective travel origination or destination, the class of travel (e.g., first, coach, etc.), or other details of the trip's prospective itinerary. At the same time, such information could be easily incorporated into the system and method according to the invention, to further evaluate the merits of a trip's itinerary based upon more objective criteria, either predefined or defined by the systems administrator. It may be useful to provide the trip's planned departure date, to serve as an easy method for a user to distinguish between multiple travel opportunities and to allow proper evaluation thereof. It should also be noted that weights or other evaluation parameters ascribed to survey questions or responses to the survey questions may be broadly characterized in a number of different manners. As merely an example, weights or other evaluation parameters associated with survey questions or responses to the survey questions may be given no weight if desired. A question and/or response may be used simply to characterize or categorize trip records or for some other desired purpose. Examples of such responses may include the reason for the trip, the expected cost of trip, the user's job function, whether the trip is individual or group travel, etc. Therefore, the evaluation parameter, such as a weighting, given to some questions and/or responses may have no significance in the evaluation or scoring, or may have uniform weights such that no question or response carries more weight than any other questions or response, or may have unique weights assigned at the discretion of the system's administrator.

As merely an example of implementation of the survey system as described above, the basic structure of the pre-trip survey database may have the following characteristics:

Question Table

| Question ID | Question Text | Question Weight |
|---|---|---|
| Q1 | How important is this trip? | 100 |
| Q2 | To what extent have you considered | 75 |
| | non-travel alternatives? | |

Question-Response Table

| | | | Response |
|---|---|---|---|
| Question ID | Response ID | Response Text | Weight |
| Q1 | R1 | Extremely | 10 |
| | | important | |
| Q1 | R2 | Very Important | 8.5 |

Scoring Rules Table

| Min Score % | Max Score % | Scoring Message |
|---|---|---|
| 90% | 100% | “Take the trip” |
| 75% | 89% | “Take the trip if you |
| | | are sure it's necessary |

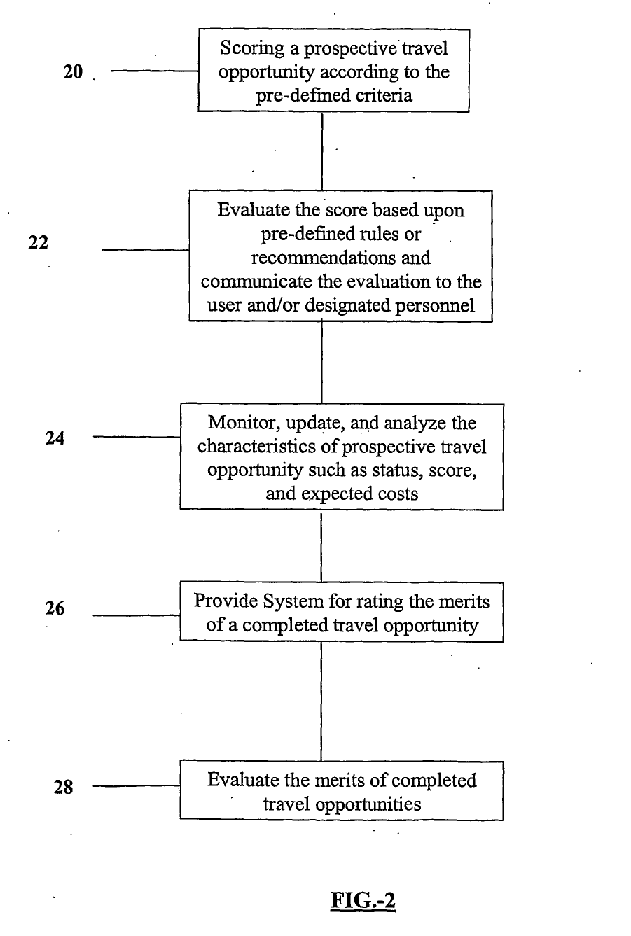

From the foregoing, a score for the trip record based upon the responses from the user to the survey's questions may be presented to the user as indicated at 14, wherein the rule or recommendation associated with the score is provided to the user. The rule or recommendation may be input by the survey system's administrator or otherwise determined based upon predefined criteria. As seen in FIG. 2, the method and system according to the invention may further comprise the step of scoring or rating a prospective travel opportunity according to the predefined criteria at 20. This score or rating can then be evaluated based upon predefined travel rules or recommendations and communicated to the user and/or the organization's management at 22. The system and method can monitor and/or report the status, score, expected costs and/or other information on prospective travel opportunities to designated individuals at 24. Note that a score or rating can take a quantitative form such as a number or percentage, or a word-based form, such a “Good”, “High”, “Fairly Acceptable” or the like. In addition, the system may allow for rating or valuing the merits of a particular consummated travel opportunity at 26, and evaluating the merits of consummated travel opportunities at 28. As an example, and with reference to this example of the invention, the trip record's score may be calculated by:
1. Finding the set of questions that the user responded to;
2. For each question in this set, find the maximum value of the question's responses as recorded in the Question-Response Table;
3. Multiply each question's assigned weight by the maximum value available from the question's responses to derive a Maximum Question-Response Value;
4. Sum the values of these Maximum Question-Response Values and use this summed value as the trip record's denominator;
5. For each question used in the survey, find the response selected by the user and multiply this response's value by the question's assigned weight to derive a Scored Question-Response Value;
6. Sum the values of each scored question-response value, and use this summed value as the trip record's numerator;
7. Divide the trip record's numerator value into the trip record's denominator value to obtain the trip record's percentage score.

Note that there are many possible alternative methods of calculating a trip record's score, such as by using all the questions and their maximum response values as the basis for the score's denominator, regardless of whether a question was answered. Note also that some questions may take the form of multiple-choice answers, wherein adjusting the values of the potential responses for example can accommodate this form of question. Note that the “weight” or evaluation parameter may take the form of points, as illustrated in this example, or the form of a percentage, such that when all the relevant questions are evaluated the sum of their percentages adds to 100%. Other suitable approaches to weighting or providing evaluation parameters for analyzing trip record data are contemplated within the invention. After presenting the trip record's percentage score and preferably the designated scoring message to the user, allow the system to record the user's intention regarding the prospective trip, preferably using an indicator such as “decline the trip” or “decide later” or “accept the trip” or other meaningful indicators of the user's intention about whether or not the trip will be taken. It is contemplated that the user may not be the traveler or the prospective traveler, but may be authorized to access the system on the traveler or prospective traveler's behalf.

The system and method may also provide for storage of a set of e-mail addresses or other communication information associated with each user, and/or allow the system administrator to designate one or more e-mail addresses as required recipients of selected trip record's details, preferably to include the trip record's score and the user's intention. The trip records selected for required e-mailing may be based on such factors as the user's intention, the trip record's score, the estimated cost of the trip or other such meaningful characteristics of the trip record.

The system and method may also record and present the status of each trip record, preferably using desired indicators, such as “declined”, “pending”, “accepted” or “taken” or their equivalents or similar indicators. The system and method may allow multiple employees of the organization to view and analyze these trip statuses and trip records in accordance with some form of administrative rights as decided by the survey system's administrator.

The basic format for storing and displaying the trip records may be:

Trip Record Table

| Trip | Planned | | Trip Status | | | Value of |
|---|---|---|---|---|---|---|
| Record | Departure | User | (or Trip | Trip | Estimated | Trip, If |
| ID | Date | Name | Intention) | Score | Trip Cost | Taken |
| 1001 | Dec. 12, | John | Will Take | 45% | $2,500 | |
| | Dec. 12, | John | | | | |
| | 2001 | | | | | |
| 1002 | Nov. 30, | John | Taken | 68% | $1,000 | Fairly |
| | 2001 | Smith | | | | Valuable |
| 1003 | Nov. 15, | John | Declined | 34% | $1,500 | |
| | 2001 | Smith | | | | |

One skilled in the art will recognize other similar ways to organize and display the trip record data.

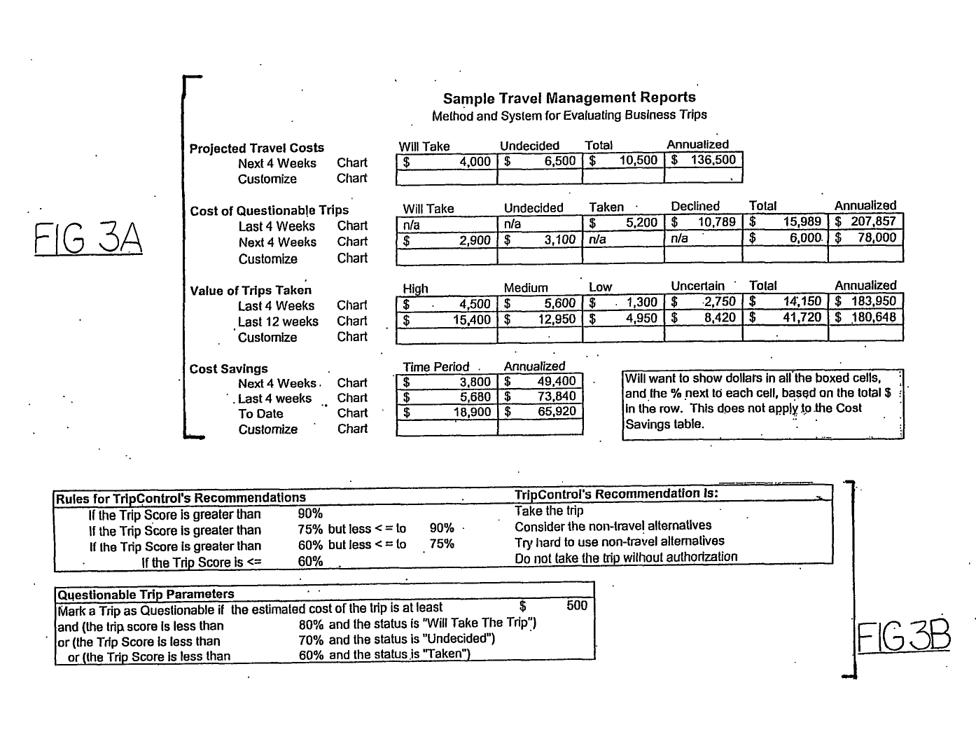

The system may also allow other functions to be completed as desired for a particular organization or circumstance, such as allowing the user to modify the status of their recorded prospective trip records, such as changing the trip record's status from “pending” to “declined”. In addition, to support the evaluation of the merits of travel opportunities taken at 28, the system may require the user to indicate the value of trips taken, such as by assigning the taken trip a rating or score, such as “very valuable” or “8” on a scale of 1-10. The system may also allow the system administrator or other authorized individuals to query, sort, view and analyze the various trip records stored in the trip record, database. The system may also generate reports that facilitate the monitoring of pending trips, the assessment of the value of trips taken, as well as the value of trips avoided. Examples of such reports may include those identifying 1) relatively expensive trips that scored below a specified level and have not been declined by the prospective traveler; 2) the expected cost of pending trips; 3) the traveler-rated value of trips taken; 4) the estimated cost of declined trips; and other reports using the type of information captured by the system. Example of Management reports and summaries are shown in FIGS. 3A and 3B respectively. One skilled in the art will recognize that these reports are very useful, and yet are merely illustrative of the type of data and method of organization that is possible given the features of this invention.

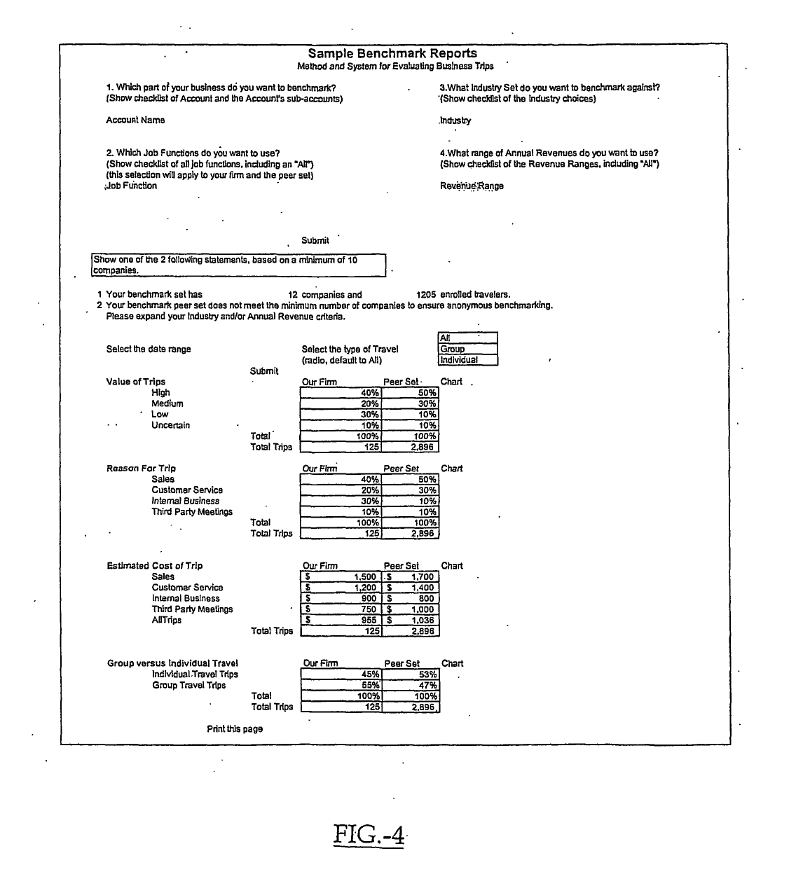

The system and method also may allow the system administrator and other authorized users to query, sort, view and analyze the various trip records of their organization as well as those trip records of other organizations, as may be selected by the system administrator or other authorized user. The ability to aggregate the trip record or other data for a plurality of organizations or individuals provides a very powerful tool for characterizing travel or other opportunities based upon more objective criteria ascertained from the data based upon historical analysis. Preferably, the trip records of other organizations would be aggregated and/or made anonymous prior to such an analysis so that each organization's data about its trips would remain confidential. An example of such a record is shown in FIG. 4. One skilled in the art will recognize that these reports may be of any suitable or desirable character to evaluate the opportunity, and the report shown is merely illustrative of the type of data and method of organization that is possible given the features of this invention. The invention therefore provides a method of accumulating opportunity related information from a plurality of organizations or individuals. In such an embodiment, the information is electronically received from a plurality of users, and may be responses to a plurality of survey questions or statements relating to travel opportunities or trips taken for example. The information may comprise data selected from the group consisting of data about the type of trip, the purpose of the trip, the perceived value of the trip, information relating to travel characteristics of a travel opportunity or taken trip, information regarding the merits of a travel opportunity or taken trip, information about the traveler or prospective traveler, information about the traveler or prospective traveler's organization, information about the organization's industry or activities, information about the organization's revenue, information on the organization's travel characteristics or some component of travel taken by the organization and combinations thereof. The questions and responses can be electronically stored, and subsequently processed and/or provided to other users. This allows users to obtain and evaluate travel characteristics of larger related groups within the user's organization or based upon data from other organizations of predetermined demographics for example.

### ILLUSTRATIVE APPLICATION OF THIS INVENTION

ABC Company decides to apply this invention to help manage its travel costs. It designates an employee as the corporate system administrator (CSA). The CSA works with the supplier of this system and perhaps the supplier's designated system administrator (SSA) to perform these steps:
1. Create a new questionnaire or copy or modify an existing questionnaire to be used by ABC.
2. Assign, accept or modify existing weights to the questions and their potential responses.
3. Cause ABC travelers to use the system, preferably by enrolling them as users under the ABC account ID.
4. Assign, accept or modify the scoring messages to be displayed to ABC's users once their trip records have been scored.
5. Select which if any e-mail addresses are to receive notices of trip records created by users, and under what conditions
6. Establish the parameters, if any, which may designate a trip record as questionable.

These steps may be performed by the CSA by accessing the system supplier's website or communicating verbally or in writing with the SSA, or in other similar fashion.

Once the ABC account has been set up, ABC's users would access the system preferably via the Internet. A user would log onto the website by entering their identity and password, and be able to perform such functions as create or edit their user profile, create or edit a trip survey, view and update their trip records, and if authorized, view and analyze the ABC set of trip records as well as other companies' aggregated and anonymous trip records.

To evaluate a prospective trip, the user would initiate the system's trip scoring module. The user would be presented a set of questions to which he must respond by selecting from the available responses or providing an answer in some other fashion, such as a few words or sentences about the purpose of his prospective trip, his primary destination, etc.

After completing the survey, the user will receive the trip record's score via the system's website, along with the pre-programmed recommendation based on ABC's choices of scoring messages. The user will then be asked to state his intention about the trip, preferably such as “will take the trip”, “will decide later” or “will decline the trip”. Once he has stated his intention, the system stores this trip record and sends an e-mail to whichever e-mail addresses have been designated by the CSA and the user.

An ABC manager may receive a notice, such as an e-mail or page, reporting that a user intends to take a trip. The notice may include such information as the estimated cost of the trip, the trip record's score, the associated recommended action, the user's intention, as well as an indicator that this trip is questionable based on the ABC-defined parameters for a questionable trip, or other such relevant information. The manager may then choose to contact the user about the prospective trip. Note that this action by the manager is not a required element of this invention.

The user may be prompted to update those trip records whose planned departure dates are in the past. If a user has taken a trip associated with a trip record in the system's database, the user may be prompted to change its status to “taken” and to rate its value, such as “High” or “Clearly beneficial” or “8” on a 10-point scale, or make other similar evaluations.

An authorized user of the ABC system may analyze the trip records by accessing the system's website and entering the criteria for the type of trip records to be analyzed. The system may store a number of reports and make these available to the authorized user. Preferably, the system will allow the user to print and export the relevant data and/or reports for further use.

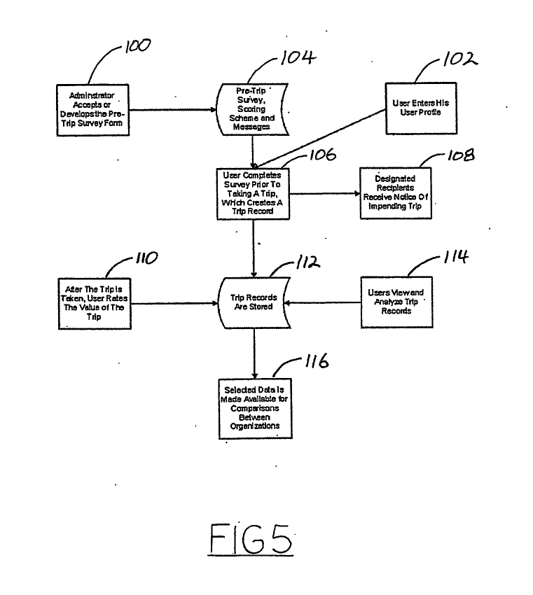

FIG. 5 is a flow diagram of another embodiment of the method according to the invention. This, as well as potentially other embodiments, may be implemented in a computer system employing a relational database accessible through the Internet or other global information system by a computer system comprising a data input device, a processor, and a user interface. The system utilizes the relational database to store and recall data and is made accessible thorough a web page available either locally or remotely through the Internet.

Upon system implementation, a system administrator may configure a pre-trip survey comprised of questions and statements in the configuration step 100. These questions or statements may be weighted independently of one another in accordance with a variety of factors, including but not limited to, an organization's travel costs, policies, budgets, goals, projections, managerial judgment and other relative factors. Independently of the system configuration step is a profile entry step 102 in which a potential traveler or user of the system is prompted to enter personal information into the system that form his or her user profile. This profile may include a variety of information, including but not limited to, job-function, types of travel number of trips taken or planned, travel allowance, payment card account number and travel account number. This user profile is stored by the system and is recalled whenever the user accesses the system.

For an embodiment relating to a prospective travel opportunity or any other prospective opportunity, a user of the system completes a pre-trip or pre-opportunity survey at step 104. The user invokes this step when the user would like to evaluate the merits of prospective travel or another opportunity. The user is prompted, by means of a survey system, with a plurality of questions or statements relating to the prospective travel or other opportunity. Once the user completes the process of entering responses to the questions or statements into the system, the system scores the prospective travel by evaluating the users responses based upon predefined criteria, recommendations or rules and returns a score and recommendation.

Completion of the pre-trip survey step will cause creation of a trip-record in the system 106. Completion of the pre-trip survey step will also result in initiation of a trip notification step 108 in which information regarding the particular prospective travel and its merits are communicated to pre-defined management or other administrative or designated personnel. Also initiated upon completion of the pre-trip survey step is the trip-record storage step 112 in which all information entered into the system regarding the prospective travel is stored. After the trip is taken, a user may update the trip-record with new information involving an assessment of the value of the trip. This updating process is referred to as a value rating step 110 and its completion results in storage of the trip-record through the trip-record storage step 112. The system provides an internal analysis step 114 in which management and users may then access data from the trip record and any other trip records that have been stored and analyze the organization's overall travel data. The system also provides a benchmarking step 116 that extracts certain data from trip-records generated by multiple users at multiple organizations. The aggregation of data from a plurality of organizations or users can then allow an organization or other user to compare that information with information related to their own organization for example.

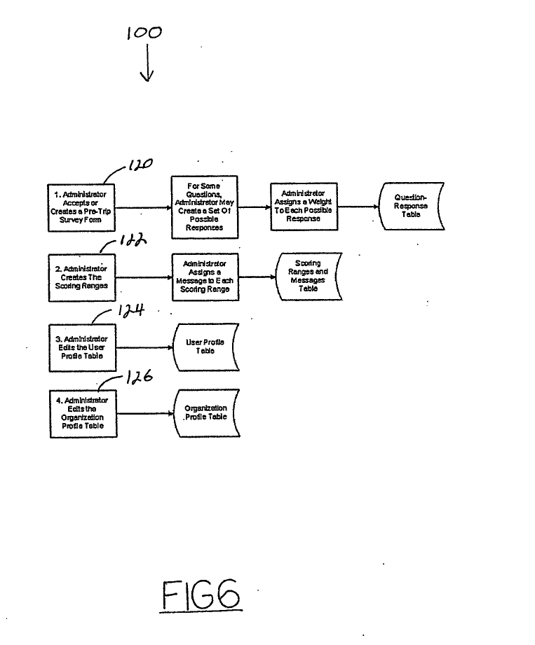

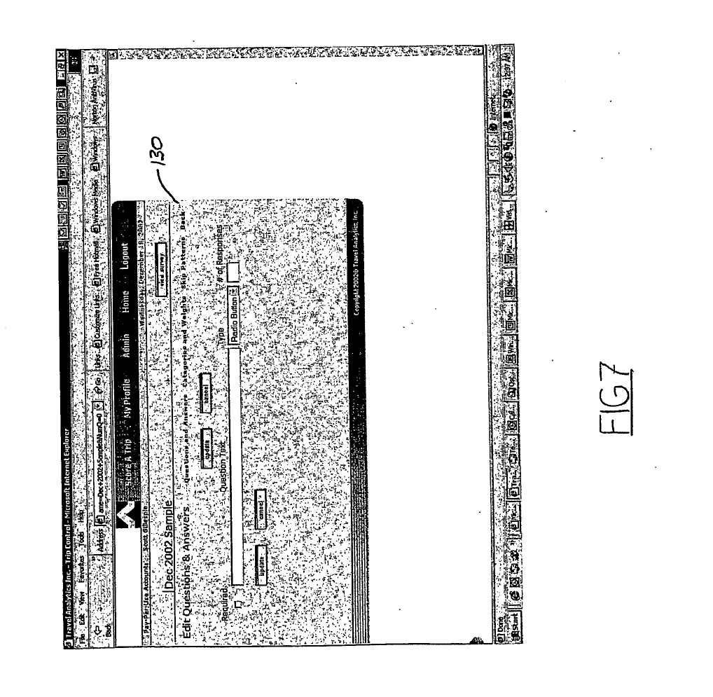

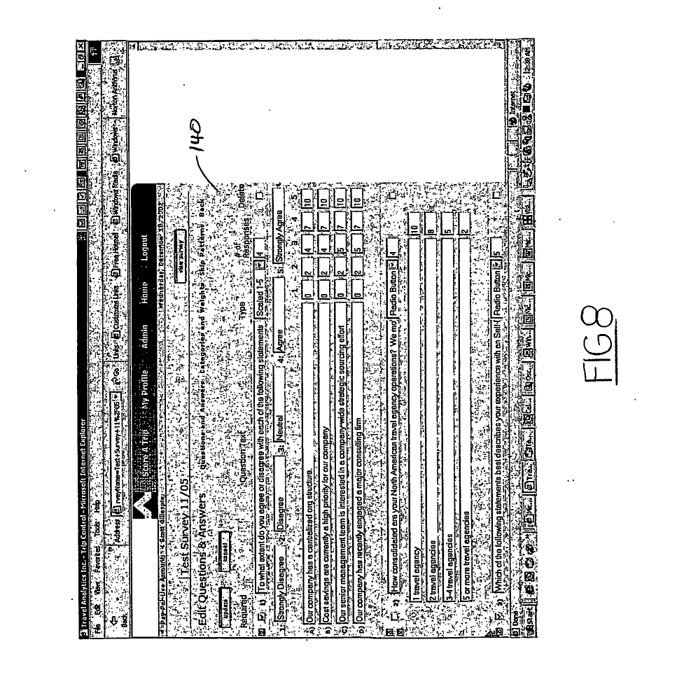

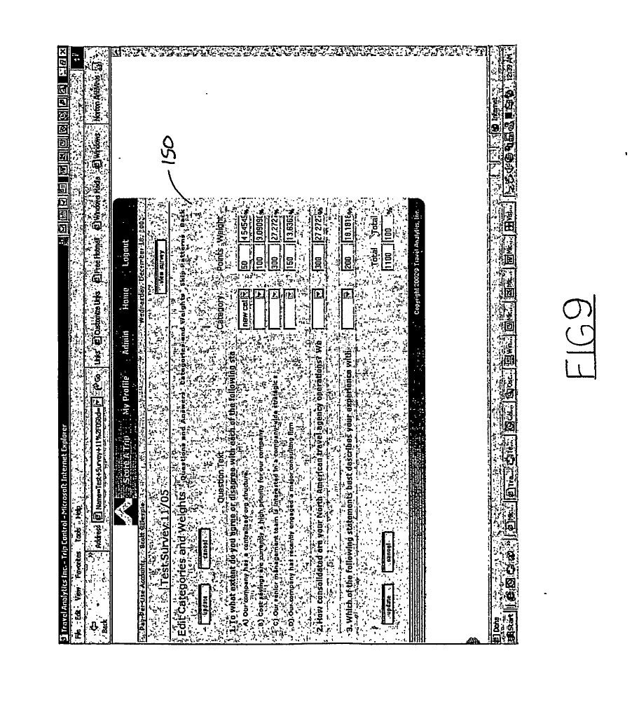

Referring now to FIG. 6, a system administrator may configure a pre-trip survey system comprised of questions and statements, tables and profiles in the configuration step 100. The process of further developing a pre-trip survey system may be accomplished through four major processes. The first process is the survey creation process 120 in which the administrator may accept, modify or create a set of pre-trip survey questions and/or statements. For some questions, the administrator may create a set of allowed responses. These administrator functions may be carried out through the use of a question or answer editor form 130 (FIG. 7), and/or a survey editor form 140 (FIG. 8). The administrator also will assign a weight to each survey question or statement based upon the organization's travel costs, policies, budgets, goals, projections, managerial judgment and other relevant factors. This is accomplished using a response weight editor form 150 (FIG. 9). This information is collected and stored in the system.

The second major process is the score range creation process in which the administrator sets acceptable travel scoring ranges. Once these ranges are established and set, the administrator may set messages corresponding to certain scoring ranges. For example, the administrator may configure the system to return a message from management for trip-records that score between 40% and 60% that reads “Requires Mgr Approval”. The third major process is the user profile configuration process 124 in which the administrator may configure what information about system users will be stored. This information may include variety of information including job-function, type of travel, number of planned or taken trips, payment card number, employee number, travel allowance, and travel account number. This will result in formation of a user profile table in the relational database. The forth and final process of the configuration step 100 is the organization profile configuration process 126. The administrator may set certain organizational data fields in an organization profile table in which information relating to the particular organization is stored. This information may be based on a variety of factors including industry, organization size or revenue, amounts spent or budgeted on travel and the like.

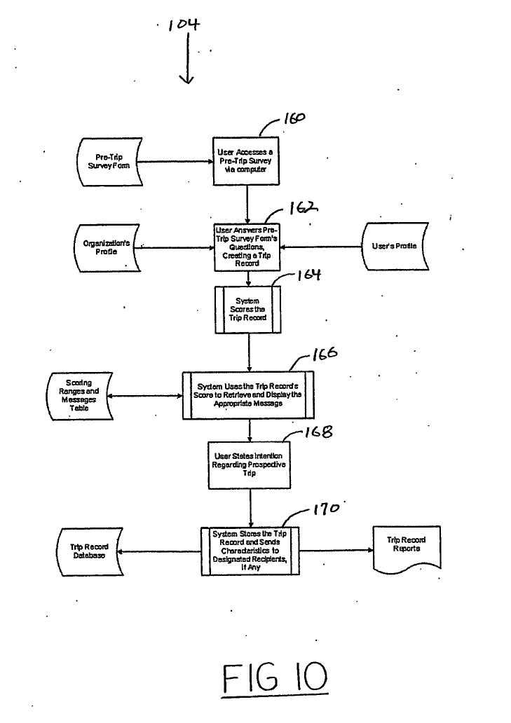

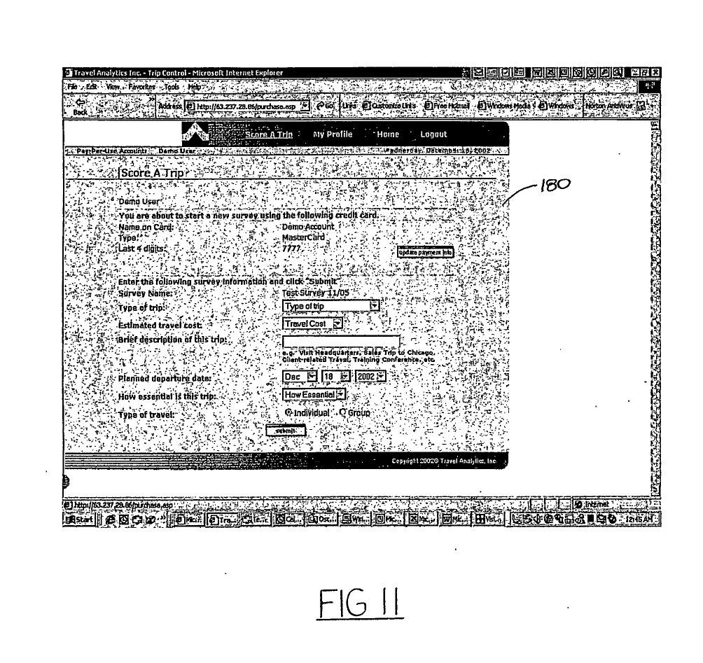

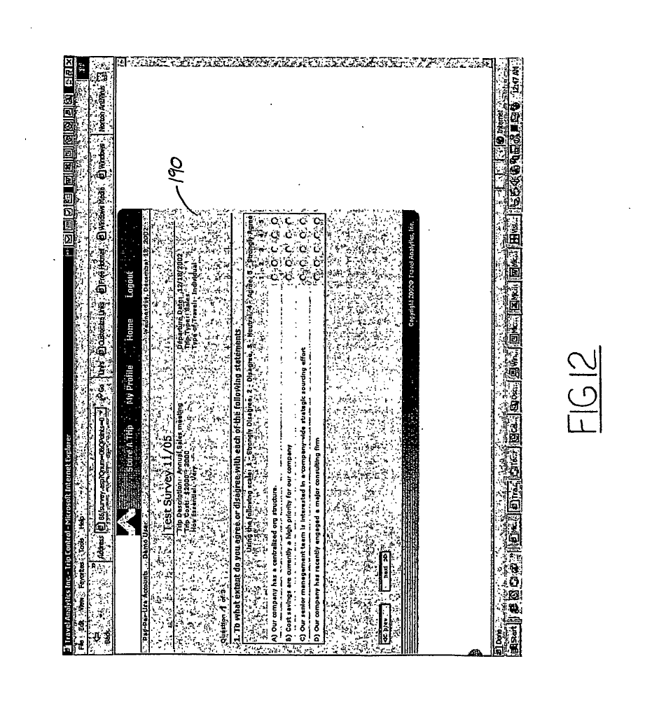

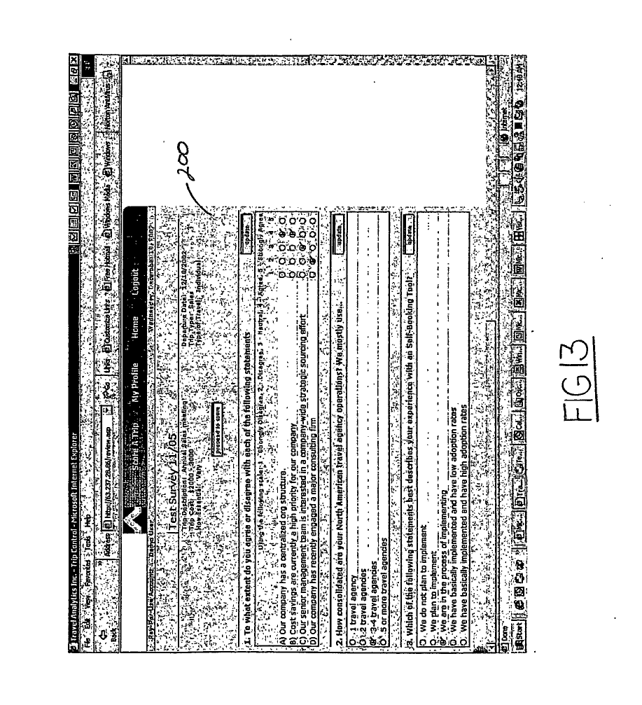

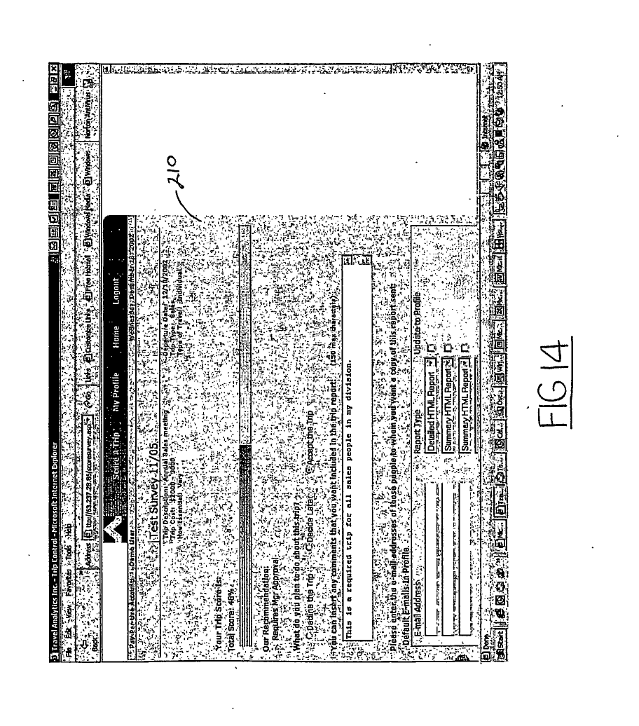

Referring now to FIG. 10, a user of the system completes a pre-trip survey step 104. Prior to prospective travel, a user will access the pre-trip survey 160. The user will be asked to enter required information into a pre-trip initiation form 180 (FIG. 11). The user will then answer a series of questions or rate a series of statements presented on a pre-trip survey form 190 (FIG. 12). After completing all pre-trip survey questions and ratings, the user will be presented with a summary of all of his or her responses through a completed survey summary form 200 (FIG. 13). The user's responses 162 to the pre-trip survey 160 and the predefined weighting data are then used to score 164 the pre-trip survey and return a score-dependent message 166 from the scoring/messages table. This score and score-dependent message 166 is communicated on a survey result form 210 (FIG. 14). The user may then choose to state their intention 168 regarding the potential travel. Subsequent to completion of this step, all entered and computed data is stored 170 in the trip-record.

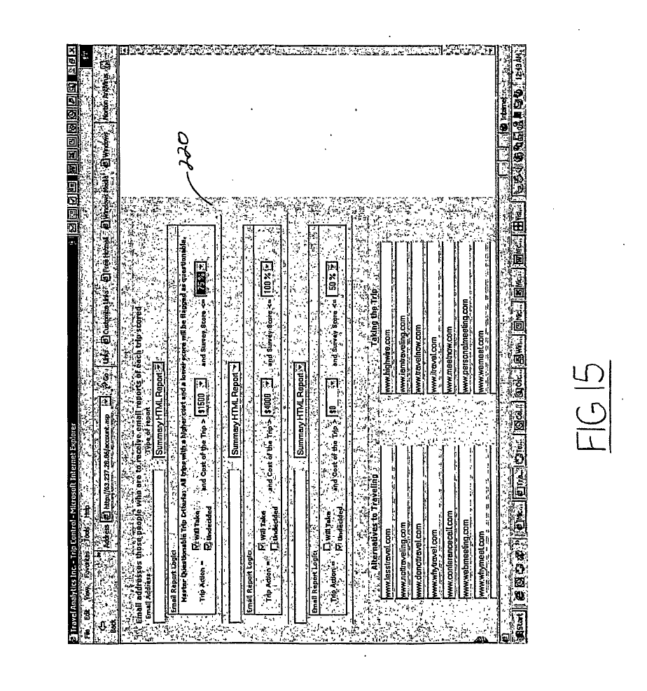

The system administrator may choose when configuring the system to notify certain individuals or departments of a potential trip upon creation or storage of trip records that meet certain criteria. A system administrator chooses under what criteria notification is sent and who will receive notification through the use of a notification editor form 220 (FIG. 15). Note that the functionality of this system does require the user or prospective traveler to obtain approval from an authorized person in order to take the travel opportunity, although the system administrator may choose to include messages to this effect.

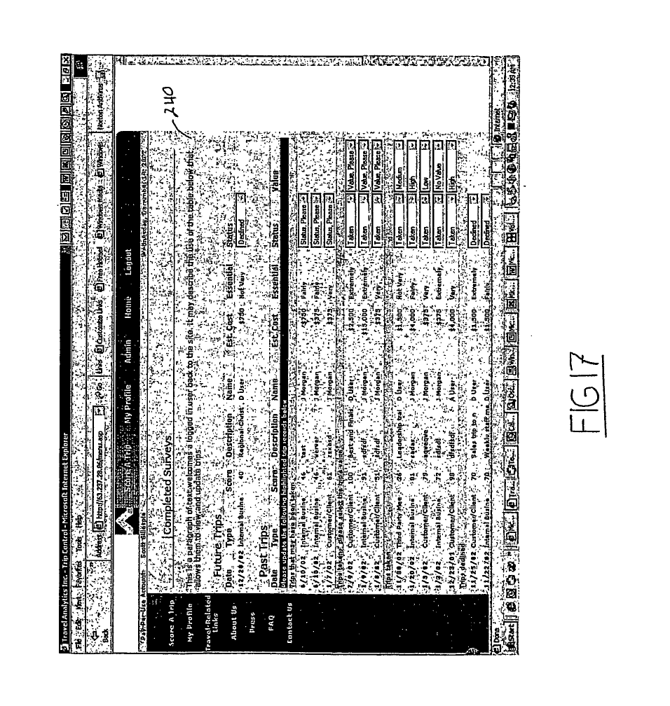

Referring now to FIG. 10, a user of the system completes a value rating step 110 after the travel opportunity has been consummated. Upon completion of a trip, a user can access the previously created trip-record and update the information at 230. Upon user login, the system displays a list of all trip-records created by or accessible to that user on a trip-record list form (FIG. 17). The system will display the trip-record selected by the user. The information is updated at 232 by providing information regarding the rating of the value of the trip. This information may include both objective and subjective valuations of the trip or other characteristics or information. Once the information regarding the value or other characteristics of the actual trip is entered, the trip-record is stored at 234 in the database. From a collection of stored trip-records, trip-record reports may be generated at 236.

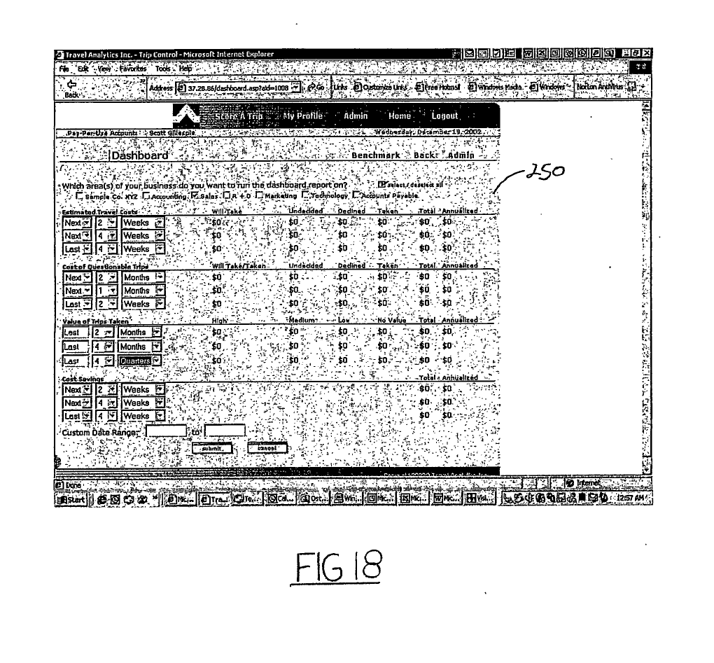

The system may provide an internal analysis step at 114 in which management and users may then access the trip-record and any other trip records that have been stored and analyze each trip independently or against other trip-records of the organization or other organizations. This step is performed by gathering certain data from a collection of trip-records and performing certain management specified calculations. FIG. 18 is a sample internal analysis form 250 that allows a manager or a user to initiate and perform the internal analysis step 114.

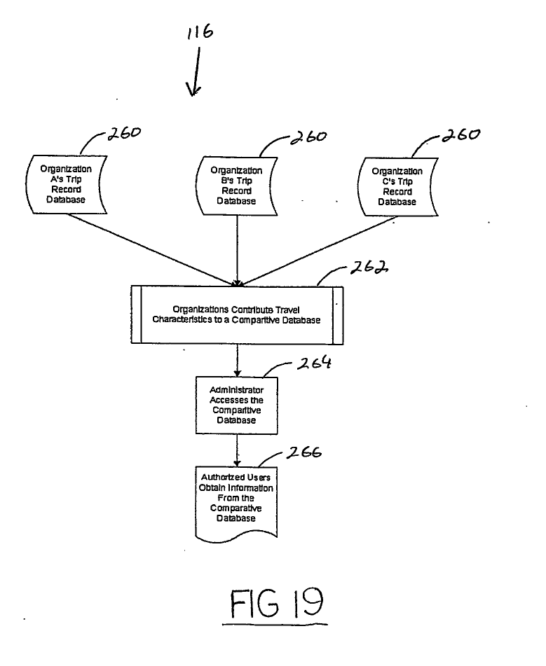

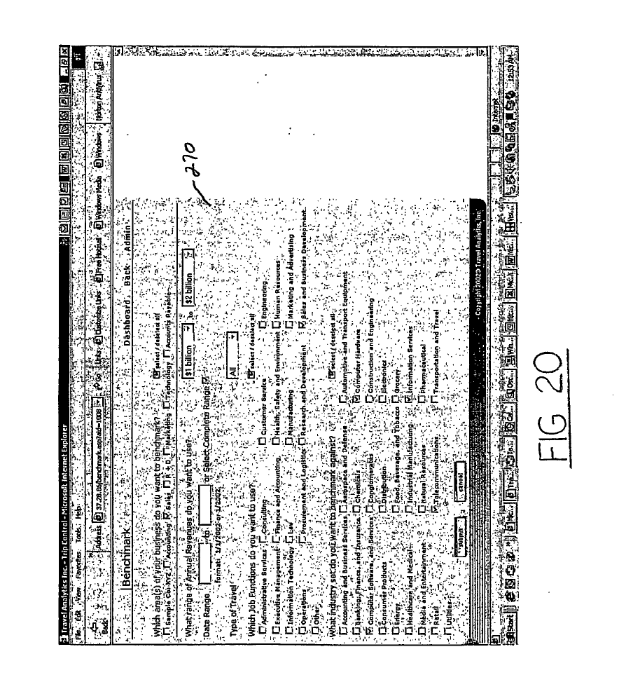

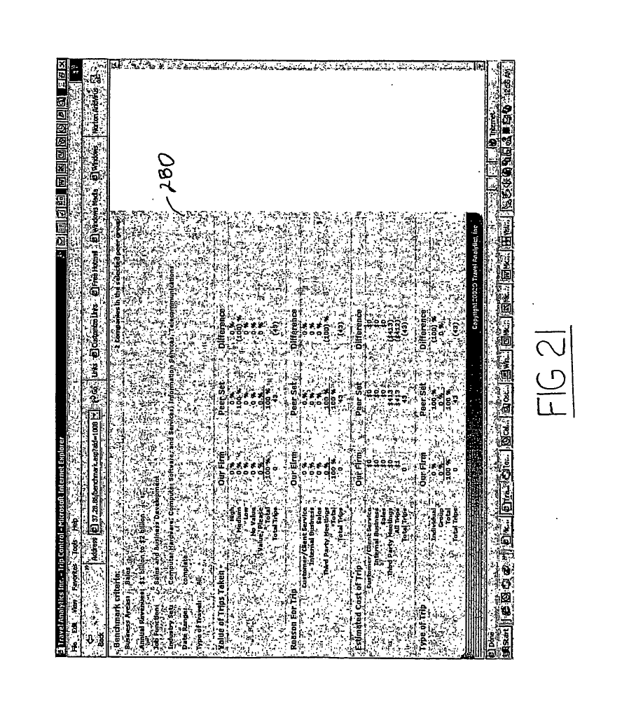

Referring now to FIG. 19, the system may perform a benchmarking step 116. Management or a user may choose to benchmark the travel characteristics of their organization against the travel characteristics of other organizations by comparing data extracted from other organizations' trip-records 260. This extracted data is then entered 262 into a comparative database. An administrator may then access 264 data from this comparative database and allow authorized users to obtain information 266 from this data. Authorized users may be able to select the criteria for requested information through the use of a benchmark selection form 270 (FIG. 20). Once the benchmarking function is performed, the system may generate and/or displays a benchmark report 280 (FIG. 21).

Although preferred embodiments of the invention have been described herein, various modifications or variations will be apparent to one skilled in the art without departing from the principles and teachings herein. Accordingly, the invention is not to be limited to the specific embodiments illustrated, but is only intended to be limited by the scope of the appended claims.

1. A method of evaluating the merits of a prospective travel opportunity comprising the steps of:
a) providing a survey system having a plurality of survey questions or statements relating to a prospective travel opportunity, to be responded to by a user, wherein the survey system communicates and stores information selected from the group consisting of survey questions or statements, evaluation parameters relating to questions or statements, potential responses, evaluation parameters relating to potential responses, actual responses or combinations thereof;
b) evaluating actual responses to the plurality of survey questions or statements against pre-defined criteria to provide an evaluation indicator relative to a prospective travel opportunity; and
c) providing at least one user with information regarding the merits of the prospective travel opportunity based upon the evaluation against the pre-defined criteria.

2. The method of claim 1, wherein the evaluation indicator comprises a score, recommendation or rating relative to the prospective travel opportunity.

3. The method of claim 1, wherein the system records the intention of the user regarding whether the prospective travel opportunity will be taken.

4. The method of claim 1, wherein the evaluation parameter is assigned a numerical value.

5. The method of claim 1, wherein the user receives an indication of the merits of the travel opportunity.

6. The method of claim 5, wherein the merits of the travel opportunity are evaluated relative to non-travel alternatives.

7. The method of claim 1, wherein the information regarding the merits of the prospective travel opportunity is communicated to a designated user in an organization to allow monitoring of travel activities in the organization.

8. The method of claim 7, wherein the intention of the traveler with respect to taking the prospective travel opportunity is communicated to the at least one designated user.

9. The method of claim 1, wherein the method is implemented on a global information system.

10. The method of claim 1, wherein the plurality of survey questions or statements are capable of being created, edited, and stored in the survey system by the user.

11. The method of claim 10, wherein at least one designated user is provided with authority to create and edit survey questions or statements.

12. The method of claim 1, wherein particular survey questions or statements are related to information to characterize or categorize a travel opportunity.

13. The method of claim 12, wherein the survey questions or statements relating to characterizing or categorizing a travel opportunity are selected from the group consisting of the type of trip, the reason for the trip, the expected cost of the trip, the extent to which the trip is necessary, whether the trip is for individual or group travel or combinations thereof.

14. The method of claim 1, further comprising the rating or scoring of the prospective travel opportunity based on predefined evaluative criteria.

15. The method of claim 1, wherein the system provides storage for communication information relating to users within an organization for communicating said information within an organization.

16. The method of claim 2, wherein the score, recommendation or rating of the prospective trip as part of a trip record is calculated by the steps further comprising:
finding the set of the questions or statements that the user responded to;
finding a maximum value of the available responses to the questions or statements in the set of questions or statements as recorded in a question-response table;
deriving a maximum question-response value by multiplying the weight of each question or statement by the maximum value from the available responses to the questions or statements;
calculating a trip record denominator by summing the values of the maximum question-response values;
deriving a scored question-response value by finding the response selected by the user for each question used in the survey and multiplying the value of the response by the assigned weight of the question;
calculating a numerator for the trip record by summing the values of each scored question-response value; and
calculating the percentage score of the trip record by dividing the numerator of the trip record into the denominator of the trip record.

17. A method of evaluating an opportunity comprising the steps of:
a) providing a survey system having a plurality of survey questions or statements relating to an opportunity, to be responded to by a user, wherein the survey system communicates and stores information comprising at least survey questions or statements, evaluation parameters relating to the questions or statements, potential responses, evaluation parameters relating to responses, and information relating to actual responses;
b) evaluating actual responses to the plurality of survey questions or statements against pre-defined criteria and generating an evaluation record; and
c) providing at least one user with at least information regarding the evaluation of said opportunity based upon the evaluation against the pre-defined criteria and a recommendation relating to said opportunity.

18. A method of evaluating opportunities comprising;
a) displaying a plurality of survey questions or statements relating to a prospective opportunity;
b) receiving a user's responses to said plurality of survey questions or statements,
c) evaluating the user's responses to said plurality of survey questions or statements against pre-defined criteria to provide an evaluation indicator relative to a prospective opportunity; and
d) displaying information regarding the merits of the prospective opportunity based upon the evaluation against the pre-defined criteria.

19. A method of evaluating an event comprising;
a) displaying a plurality of survey questions or statements relating to an event;
b) receiving a user's responses to said plurality of survey questions or statements,
c) storing the user's responses to said plurality of survey questions or statements; and
d) displaying information regarding the user's evaluation of the event.

20. A computer data signal embodied in a transmission medium comprising:
a method comprising:
a) providing a survey system having a plurality of survey questions or statements relating to a prospective travel opportunity or a completed trip, to be responded to by a user, wherein the survey system communicates and stores information selected from the group consisting of survey questions or statements, evaluation parameters relating to questions or statements, potential responses, evaluation parameters relating to potential responses, actual responses or combinations thereof;
b) evaluating actual responses to the plurality of survey questions or statements against pre-defined criteria to provide an evaluation indicator relative to a prospective travel opportunity; and
c) providing at least one user with information regarding the merits of the prospective travel opportunity based upon the evaluation against the pre-defined criteria.

21. A computer-readable medium containing instructions for controlling a computer system to evaluate a prospective travel opportunity by a method comprising:
a) providing a survey system having a plurality of survey questions or statements relating to a prospective travel opportunity, to be responded to by a user, wherein the survey system communicates and stores information selected from the group consisting of survey questions or statements, evaluation parameters relating to questions or statements, potential responses, evaluation parameters relating to potential responses, actual responses or combinations thereof;
b) evaluating actual responses to the plurality of survey questions or statements against pre-defined criteria to provide an evaluation indicator relative to a prospective travel opportunity or a competed trip; and
c) providing at least one user with information regarding the merits of the prospective travel opportunity based upon the evaluation against the pre-defined criteria.

22. A method of evaluating the characteristics of a completed trip comprising the steps of:
a) providing a survey system having a plurality of survey questions or statements relating to a trip taken, to be responded to by the user, wherein the survey system communicates and stores information selected from the group consisting of survey questions or statements, evaluation parameters relating to questions or statements, potential responses, evaluation parameters relating to potential responses, actual responses or combinations thereof;
b) storing responses to the plurality of survey questions or statements; and
c) providing at least one user with information regarding the characteristics of the completed trip.

23. The method of claim 22, wherein the characteristics of the completed trip are retroactively rated to provide a rating or score related to the completed trip.

24. The method of claim 22, wherein the rating or score for the trip is based at least in part on the traveler's judgment about the value of having taken the trip.

25. The method of claim 22, wherein reports are generated relating to the characteristics of the completed trip.

26. The method of claim 22, wherein at least one designated user can customize the survey system.

27. A method of accumulating travel related information from a plurality of organizations comprising the steps of:
a) electronically receiving from a plurality of users, responses to a plurality of survey questions or statements relating to travel opportunities or trips taken; said information comprising data selected from the group consisting of data about the type of trip, the purpose of the trip, the perceived value of the trip, information relating to travel characteristics of a travel opportunity or taken trip, information regarding the merits of a travel opportunity or taken trip, information about the traveler or prospective traveler, information about the traveler or prospective traveler's organization, information about the organization's industry or activities, information about the organization's revenue, information on the organization's travel characteristics or some component of travel taken by the organization and combinations thereof;
b) electronically storing said responses; and
c) providing at least one user with access to a set or subset of said responses.

28. The method of claim 27, wherein the method is implemented via a global information system.

29. The method of claim 27, wherein a user can obtain and evaluate information and characteristics of travel opportunities or trips taken by other users.

30. The method of claim 27, wherein the information of the travel characteristics of a user and associated trip records are compiled along with other users.

31. The method of claim 30, wherein the user is an organization and the organization's travel characteristics are evaluated relative to other organizations or users.

32. The method of claim 27, wherein the information is anonymized to protect the identity of the user.

33. The method of claim 32, wherein the anonymized information allows users to obtain and evaluate travel information and characteristics of larger related groups or based upon predetermined demographics.

34. The method of claim 27, wherein the status of each trip is recorded and presented.

35. The method of claim 27, wherein the system may allow at least one authorized user to query, sort, view, and analyze the travel information of an organization.

36. A method of evaluating the merits of a prospective business travel opportunity comprising the steps of:
a) providing a survey system having a plurality of survey questions or statements relating to a prospective travel opportunity of a business, to be responded to by a user, wherein the survey system communicates and stores information selected from the group consisting of survey questions or statements, evaluation parameters relating to questions or statements, potential responses, evaluation parameters relating to responses relating to the business, actual responses or combinations thereof;
b) evaluating actual responses to the plurality of survey questions or statements against pre-defined criteria related to the business travel opportunity to provide an evaluation indicator relative to a prospective business travel opportunity; and
c) providing at least one user with information regarding the merits of the prospective business travel opportunity based upon the evaluation against the pre-defined criteria.

37. A method of evaluating an event comprising the steps of:
a) displaying a plurality of survey questions or statements relating to an event, the questions or statements selected from the group consisting of type of event, purpose of event, value of the event, cost of the event or combinations thereof;
b) receiving a user's responses to said plurality of survey questions or statements,
c) storing the user's responses to said plurality of survey questions or statements; and
d) displaying information regarding the characteristics of the event based upon the responses to the plurality of survey questions or responses.
